(19) United States
(12) Patent Application Publication
(10) Pub. No.: US 2004/0136062 A1
(43) Pub. Date: Jul. 15, 2004

(54) Portable periscope

(76) Inventor: Avner Farkash, Shomron (IL)

Correspondence Address: Mark M Friedman, Bill Polkinghorn, Discovery Dispatch, 9003 Florin Way, Upper Marlboro, MD, 20772, US

(21) Appl. No.: 10/477,828

(22) PCT Filed: May 13, 2002
(86) PCT No.: PCT/US02/15026

(51) Int. Cl. G02B 23/08; G02B 23/22; G02B 23/00

(52) U.S. Cl. 359/402; 359/409

(57) ABSTRACT

A portable periscope (31) comprises a periscope head (58, 60), a periscope barrel (34) and a periscope elbow (64, 66). The periscope barrel is made up of a plurality of segments (36, 38, 40) that can be disassembled for transport and assembled for use. The segments are either separated from each other or are joined by hinges, making a foldable articulated periscope.

### FIELD AND BACKGROUND OF THE INVENTION

The present invention relates to precision optical instruments, and more specifically, to a portable periscope, especially a portable peritelescope.

The use of precision optical instruments for observation of macroscopic objects is well known in the art. Devices such as telescopes and binoculars are designed so as to magnify an image so that a distant object can be studied in detail. The magnification allows an observer to study an object that, for some reason, is impossible to approach or when approaching the object may cause the object to change behavior. For example, the study of wildlife is advantageously performed using a telescope or binoculars.

Telescopes are often preferred to binoculars as, for a given magnification, telescopes may be fashioned to be portable. Few are not acquainted with the telescoping telescopes used by pirates, FIG. 1, which when used may be more than a meter in length 10a, but for transport are collapsed to as small as 30 cm in length 10b.

In some instances it is desirable to ensure that an observer using a precision optical device not be observed in turn. For this purpose, a periscope is often used. A periscope 12 can be considered to be a telescope bent in a way so that only a periscope head 14 (equivalent to a telescope objective lens) is exposed to an observed object 16, FIG. 2A first deflecting element 18 (often a mirror or prism) directs light 20a entering periscope head 14 through periscope barrel 22 to a second deflecting element 24. Second deflecting element 24 deflects light through an eyepiece 26 to direct light 20c to an observer 28. Since light from object 16 travels a nonlinear path 20a-20b-20c, observer 28 can remain hidden while observing object 16. By deflecting the light, observer 28 is displaced from the line of sight 29 to object 16. The magnitude of displacement is dependent on the length of barrel 22 of periscope 12.

Often periscopes are mounted in structures such as houses, vehicles or submarines but are only rarely deployed in portable implementations. Since a barrel of a periscope must be relatively long to be useful, a useful periscope is rarely compact enough to bc truly portable.

Navir SNC (Buccinasco, Italy) manufactures an expanding periscope toy. This is a non-precision optical instrument roughly based on the teachings of “pirate ship” telescope depicted in FIG. 1. The barrel of the periscope is made of three parts, which can be telescoped apart extending the length of the periscope by roughly 60%.

U.S. Pat. No. 6,122,100 teaches of a periscope configured for use as headgear and allows simultaneous line of sight and displaced periscope observation. In U.S. Pat. No. 6,122,100 are also described two methods to extend the length of a periscope barrel. The first method includes having the barrel of the periscope made of a flexible material with accordion pleats. The second method includes using a plurality of telescoping elements to extend and collapse the barrel. Both methods described are useful in changing the magnitude of displacement from line of sight that can be attained by a periscope, but are limited in the extent to which the periscope can be collapsed for transport. The mechanisms required are difficult to manufacture precisely and are subject to damage. Since many implementations of a foldable periscope require ruggedness (e.g. pursuit of wildlife in the Australian Outback) the teachings of U.S. Pat. No. 6,122,100 are of limited usefulness. Further, as is clear to one skilled in the arts, a periscope constructed according to the teachings of U.S. Pat. No. 6,122,100 cannot implement optics having a Newtonian configuration.

It would be highly advantageous to have a portable periscope with precision optics. It would be exceptionally advantageous that such a periscope be configured as a peritelescope having Newtonian configuration optics.

### SUMMARY OF THE INVENTION

The above and other objectives are achieved by the portable periscope provided by the present invention.

There is provided according to the teachings of the present invention a portable periscope for the observation of an object by an observer made up of: a) a periscope barrel, b) a periscope head functionally associated with the periscope barrel configured to deflect light from the object into the periscope barrel and c) a periscope elbow functionally associated with the periscope barrel configured to deflect light traveling through the barrel to the observer, wherein the periscope barrel is configured to be collapsible into at least two segments and wherein, when assembled (not collapsed) the periscope barrel is configured to define a path for the deflected light.

According to a feature of the present invention the periscope of the present invention is portable in that the periscope barrel can be disassembled into a plurality of separate segments.

According to an additional feature of the present invention the periscope of the present invention is articulated in that the periscope barrel can be collapsed into a plurality of segments, the segments being mutually connected with hinges. The motion of the hinges connecting the segments can be coplanar or non-coplanar.

According to a still further feature of the present invention, the periscope is equipped with a plurality of lenses and filters, transparent to some or all wavelengths of light. The lenses are attached in the periscope head, the periscope elbow and/or in the periscope barrel, specifically in some or all of the individual segments making up the barrel. For example, one or more of the segments of the periscope barrel can include a field lens.

According to an even further feature of the present invention, when the periscope is equipped with lenses, the lenses are arrayed in a Newtonian configuration.

It is important to note that a periscope is a general term for a device that allows an observer to be situated not in line of sight of an object. A peritelescope is a periscope having magnifying optics. For the purposes of clarity, hereinfurther only the term periscope will be used to refer to both periscopes and peritelescopes.

### BRIEF DESCRIPTION OF THE DRAWINGS

The invention is herein described, by way of example only, with reference to the accompanying drawings, where:

FIG. 1 (prior art) is a depiction of a telescoping “pirate ship” telescope;

FIG. 2 (prior art) is a schematic depiction of a periscope;

FIG. 3A is a depiction of a first embodiment of the present invention, a portable periscope, in a disassembled state;

FIG. 3B is a depiction of a first embodiment of the present invention, a portable periscope, in an assembled state;

FIG. 4A is a depiction of a second embodiment of the present invention, an articulated periscope, folded inside a carrier bag;

FIG. 4B is a depiction of a second embodiment of the present invention, an articulated periscope, folded outside a carrier bag;

FIG. 4C is a depiction of a second embodiment of the present invention, an articulated periscope, during an unfolding process;

FIG. 4D is a depiction of a second embodiment of the present invention, an articulated periscope, fully unfolded and ready for use;

FIG. 4E is a close-up depiction of a joint of a second embodiment of the present invention, an articulated periscope, showing details of a hinge and a locking mechanism;

FIG. 5 is a depiction of a first segment of a periscope of the present invention having a polarizing filter preventing entry of contamination into the segment; and

FIG. 6 are cutout depictions of two afocal middle segments of a periscope with Newtonian optics of the present invention.

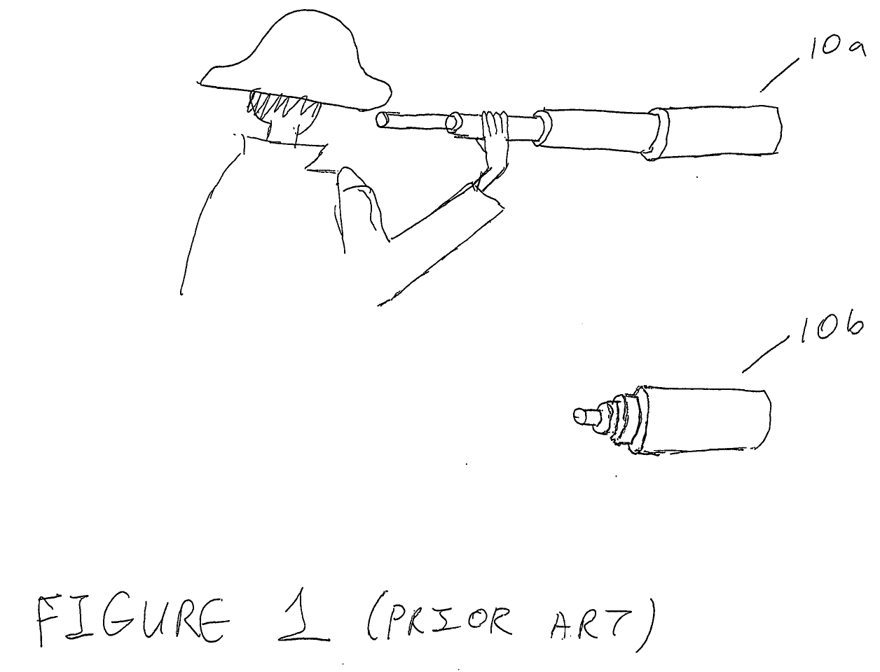

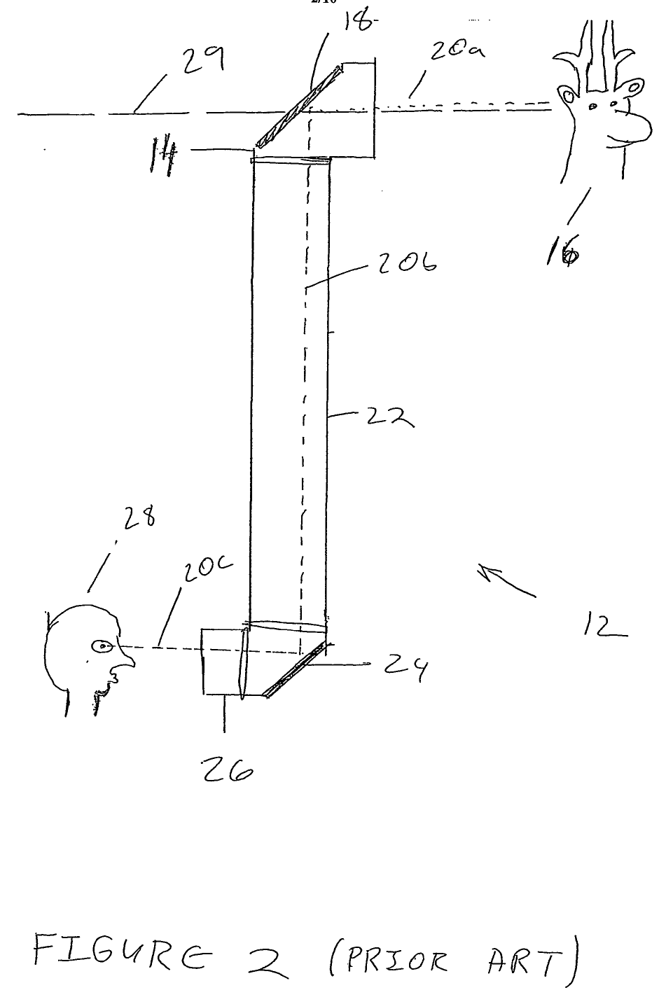

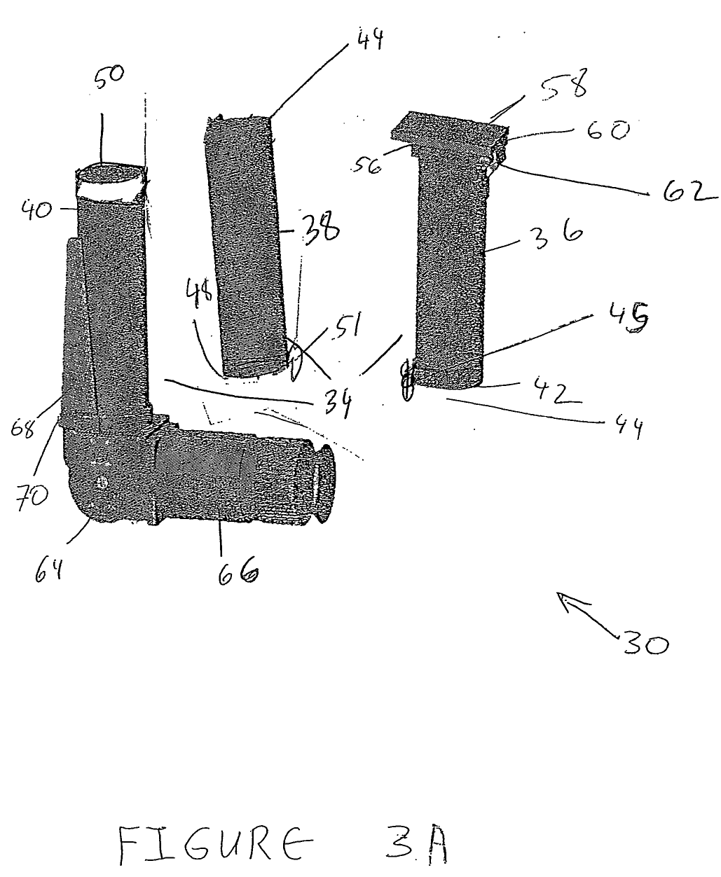

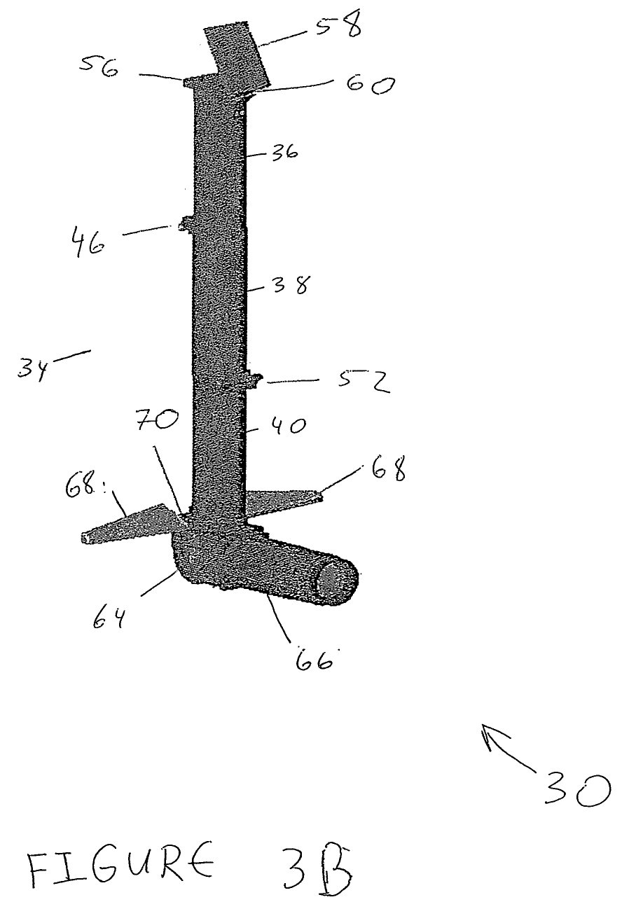

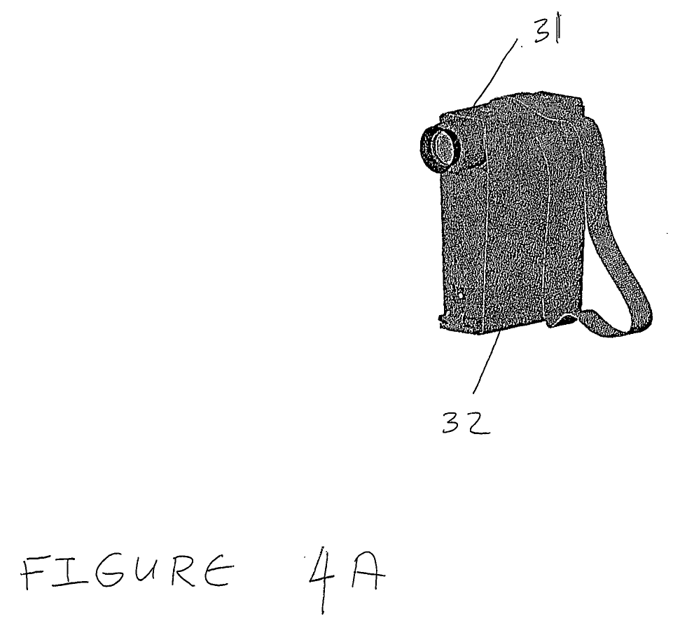

### DESCRIPTION OF THE PREFERRED EMBODIMENTS

The principles and operation of a portable periscope according to the present invention may be better understood with reference to the drawings and the accompanying description of the embodiments below, in which like reference numerals refer to like parts throughout all of the figures. It is to be understood that the descriptions below are illustrative, and are not intended to restrict the present invention to the specific details set forth below.

In FIG. 3, a first embodiment of the present invention, a portable periscope 30 is depicted. In FIG. 3A periscope 30 is depicted in a disassembled state. In FIG. 3B periscope 30 is depicted fully assembled for use.

In FIG. 3A it is clearly seen that barrel 34 of periscope 30 is composed of top segment 36, middle segment 38 and bottom segment 40. Each one of segments 36, 38 and 40 is of substantially tubular cross section. Bottom rim 42 of top segment 36 is configured to be rigidly attachable to top rim 44 of middle segment 38 with a first attaching mechanism 45. Bottom rim 48 of middle segment 38 is configured to be rigidly attachable to top rim 50 of bottom segment 40 with a second attaching mechanism 51.

First attaching mechanism 45 and second attaching mechanism 51 can be realized using a large number of mechanisms and devices with which one skilled in the art is well-acquainted. Such devices can include constricting bands or locking devices exceptionally advantageous are attaching mechanisms such as used to attach lenses to SLR (single-lens reflex) camera bodies. SLR-type attaching mechanisms are precise, rigid, quick and suitable for precision optic implementations. Also suitable for implementation in a periscope of the present inventions are threaded (screw-on) mechanisms.

Whatever the exact nature of first attaching mechanism 45 aid second attaching mechanism 51, preparation for use of periscope 30 is substantially the same. Bottom rim 48 of middle segment 38 is contacted with top rim 50 of bottom segment 40. Second attaching mechanism 51 is used to rigidly connect bottom segment 40 to middle segment 38. Bottom rim 42 of top segment 36 is contacted with top rim 44 of middle segment 38. First attaching mechanism 45 is used to rigidly connect top segment 36 to middle segment 38.

To top rim 56 of top segment 36 is attached a folding head 58. Folding head 58 is attached to top segment 36 with a lockable head hinge 60 that is lockable in two states: closed (FIG. 3A) and open (FIG. 3B). When folding head 58 is in a closed state it is rigidly held against top rim 56 of top segment 36, for example by a spring or by a locking mechanism of lockable head hinge 60. When a user chooses to open folding head 58 it is necessary to release the locking mechanism of lockable head hinge 60 or to overcome an initial mechanical resistance. Movement of folding head 58 from the closed to the open state occurs smoothly with little resistance. When folding head 58 reaches the open state it “clicks” into place and is rigidly held in an orientation and angle that is appropriate for periscope operation (for periscope 30, 45°). A protrusion 62 is configured to prevent folding head 58 from being opened beyond the appropriate orientation. Further, lockable head hinge 60 is configured to prevent movement towards the closed state when folding head 58 is in the open state. In order to move folding head 58 from the open state to the closed state it is necessary to release the locking mechanism of lockable head hinge 60 or to overcome an initial mechanical resistance.

Folding head 58 is configured including a light deflecting element (analogous to first deflecting element 18 depicted in FIG. 2) that deflects light from an observed object through barrel 34 when barrel 34 is assembled as in FIG. 3B.

It is important to note that whereas periscope 30 in FIG. 3 is depicted having a folding head 58, it is often advantageous that there be a non-folding head instead.

Bottom segment 40 is attached to an elbow 64. It is possible to configure bottom segment 40 to be easily detachable from elbow 64 if so desired. To elbow 64 is attached eyepiece 66. Elbow 64 is made in accordance with the teachings known to one skilled in the art and is configured to deflect and direct light passing coaxially through bottom segment 40 to eyepiece 66. Deflection and direction of light is most conveniently achieved through the use of a prism or mirror. This, once barrel 34 is fully assembled and periscope head 58 is open, light impinging on the light deflecting element of periscope head 58 is deflected through barrel 34 and arrives at elbow 64. In elbow 64, light traveling through barrel 64 is deflected to eyepiece 66. Periscope 30 is then ready for use.

Eyepiece 66 is a made in accordance with the teachings of the prior art and advantageously includes a system of lenses and/or filters. Lenses in eyepiece 66 include eye lenses and field lenses for magnification and focusing of an image observed through eyepiece 66. Filters in eyepiece 66 include polarization filters or wavelength specific filters.

It is clear to one skilled in the art that if eyepiece 66 includes lenses (as opposed to being simply hollow or having only filters), it is necessary that an objective lens be found somewhere in barrel 34 (or in some non-depicted embodiments, in a periscope head). Many optical configurations including an eye lens and an objective lens are known. Most advantageous is that a periscope of the present invention has optics with a Newtonian configuration. The advantages of implementing Newtonian optics in a periscope of the present invention are discussed in full, hereinbelow.

In FIG. 3 are apparent two support handles 68. Support handles 68 are attached to elbow 64 by handle hinges 70. Handle hinges 70 are lockable in two positions: in place, as depicted in FIG. 3B, and folded, as depicted in FIG. 3A. When barrel 34 of periscope 30 is fully assembled and ready for use, support handles 68 are unfolded and locked in place. A user can conveniently hold periscope 30 and direct the field of view of periscope 30 as desired. When not in use, support handles 68 are folded upwards and held substantially flat against bottom segment 40.

When it is desired to transport periscope 30, support handles 68 are folded upwards by releasing the locking mechanisms of handle hinges 70 until support handles 68 are locked into a folded position. The locking mechanism of periscope head hinge 60 is released and periscope head 58 is folded downwards to a closed position. Locking mechanisms of hinges 46 and 52 are released and barrel 34 is disassembled.

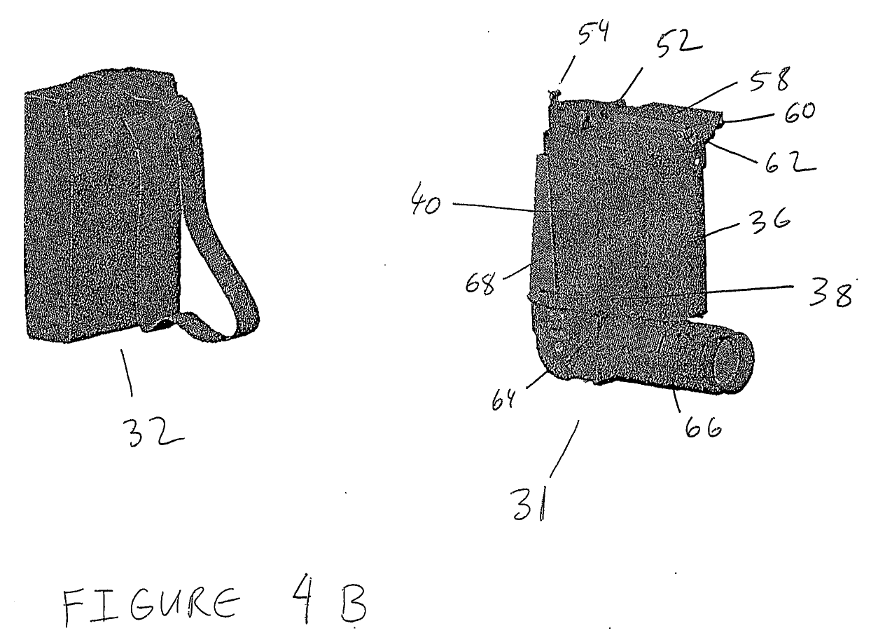

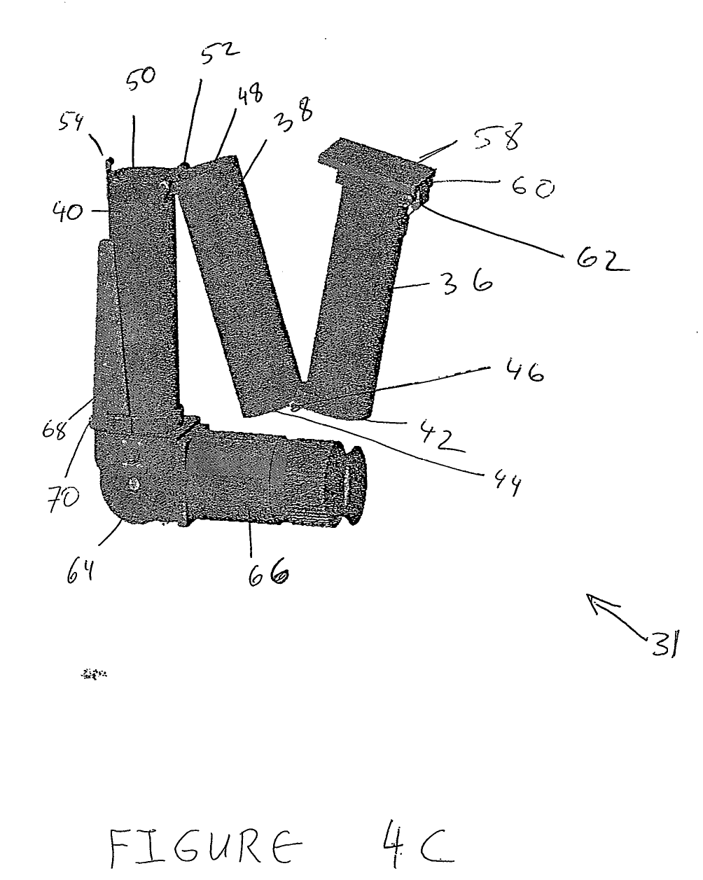

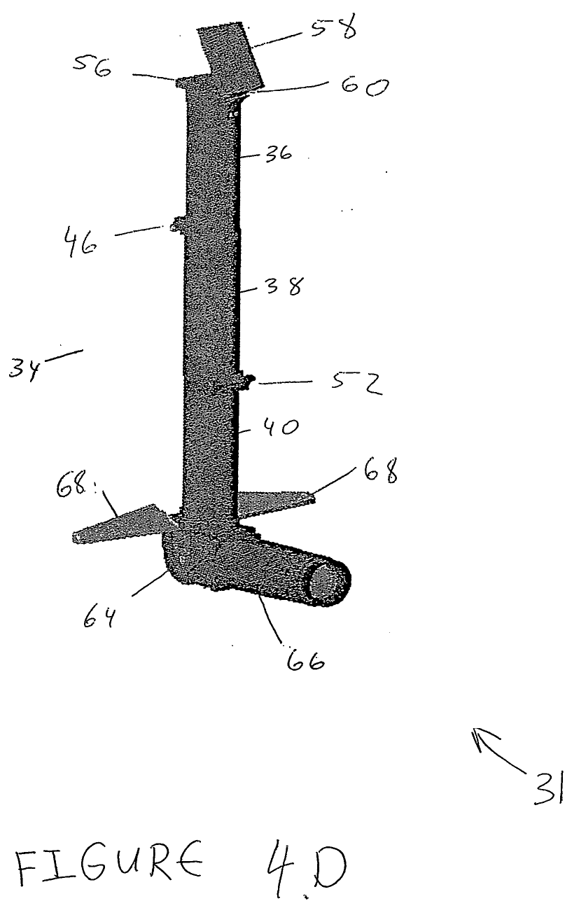

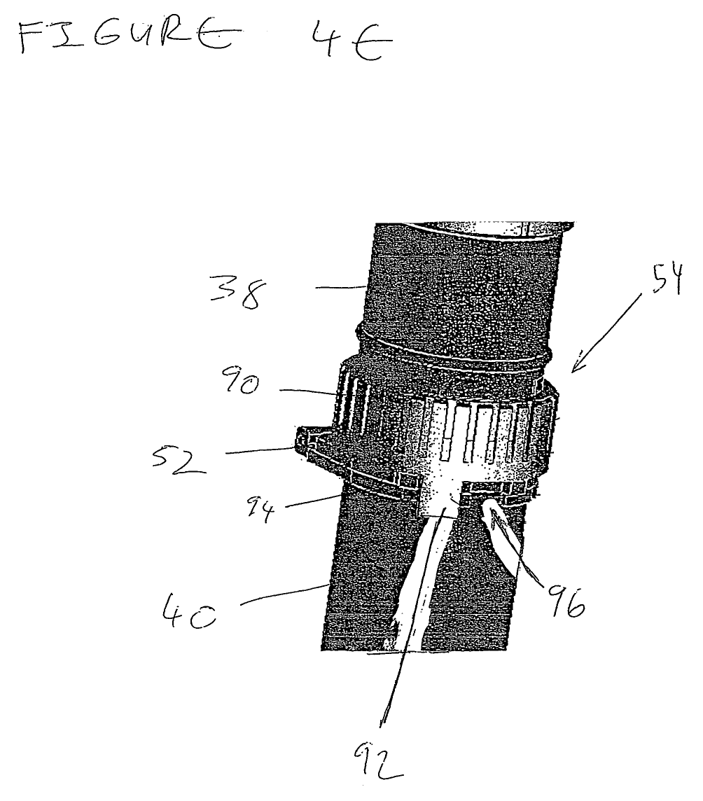

In FIG. 4, a second embodiment of the present invention, an articulated periscope 31 is depicted. In FIG. 4A periscope 31 is depicted in a folded state within a carrier bag 32. In FIG. 4B periscope 31 is depicted in a folded state after having been removed from carrier bag 32. In FIG. 4C periscope 31 is depicted during the process of unfolding. In FIG. 4D periscope 31 is depicted fully unfolded and ready for use. In FIG. 4E, a close-up view of part of periscope 31 is depicted.

In FIG. 4C it is seen that barrel 34 of periscope 31 is composed of top segment 36, middle segment 38 and bottom segment 40. Each one of segments 36, 38 and 40 is of substantially tubular cross section and all three are of substantially the same length. Bottom rim 42 of top segment 36 is connected to top rim 44 of middle segment 38 with a first lockable hinge 46. Bottom rim 48 of middle segment 38 is connected to top rim 50 of bottom segment 40 with second lockable hinge 52.

The motion of first lockable hinge 46 and the motion of second lockable hinge 52 are coplanar. As seen from FIG. 4, the coplanarity of the motion of hinges 46 and 52 allows periscope 30, when folded, to be highly compact.

The motion of second lockable hinge 52 is free and unhindered. During unfolding of periscope 31, when bottom segment 40 approaches colinearity with middle segment 38, and top rim 50 approaches bottom rim 48, locking mechanism 54 of second lockable hinge 52 is engaged. Although not necessary, a locking mechanism such as 54 can be configured to produce some resistance to motion until actually locked. Once locked, as depicted in FIG. 4D, second lockable hinge 52 cannot be moved and middle segment 38 and bottom segment 40 are rigidly attached to each other.

Similarly, the motion of first lockable hinge 46 is free and unhindered. During unfolding of periscope 31, when top segment 36 approaches colinearity with middle segment 38, and top rim 44 approaches bottom rim 42, a locking mechanism (not depicted) of first lockable hinge 46 is engaged. Once locked, as depicted in FIG. 4D, first lockable hinge 46 cannot be moved and middle segment 38 and top segment 36 are rigidly attached to each other.

As is clear to one skilled in the art, there are many and varied locking mechanisms that can be used to lock hinges such as 46 and 52 unmovably so as to prevent articulation or folding of articulated periscope 31. Some locking mechanisms are integral parts of a hinge whereas others are only associated with a hinge. For example, locking mechanism 54 is associated with hinge 52.

In FIG. 4E one example of a locking mechanism useful for realization of the present invention is depicted. Locking mechanism 54 includes a locking ridge 94 with a gap 96 at the top of bottom segment 40. Locking mechanism 54 also includes a rotating locking ring 90 with a locking lip 92 attached to the bottom of middle segment 38 and configured to engage locking ridge 94. In FIG. 4E, locking ring 90 is depicted rotated in such a way so that locking lip 92 engages the bottom of locking ridge 94 holding middle segment 38 and bottom segment 40 firmly together. When it is desired to fold articulated periscope 31, locking ring 90 is rotated rightwards so as to move locking lip 92 over gap 96. When locking lip 92 is over gap 96, locking mechanism 54 is released and middle segment 38 and bottom segment 40 are folded around hinge 52, collapsing articulated periscope 31.

To top rim 56 of top segment 36 of periscope 31 is attached a folding head 58. Folding head 58 of periscope 31 in FIG. 4 is as described hereinabove and in FIG. 3 for portable periscope 30.

Bottom segment 40 is rigidly attached to an elbow 64. To elbow 64 is attached eyepiece 66. Bottom segment 40 of periscope 31 in FIG. 4 is as described hereinabove and in FIG. 3 for portable periscope 30.

For use, periscope 31 is removed from carrying case 32, FIG. 4B. Locking mechanisms on hinges 46 and 52 are unlocked and segments 36, 38 and 40 are moved about hinges 46 and 52 until rims 42 and 48 are in contact with rims 44 and 50, respectively. Mechanisms (such as 54) are locked (either automatically or by an action of a user) so that barrel 34 is substantially a rigid tube. The locking mechanism of hinge 60 of periscope head 58 is released and periscope head 58 is moved and locked in place in an open position. Once barrel 34 is extended and periscope head 58 is open, light impinging on the light deflecting element of periscope head 58 is deflected through barrel 34 and arrives at elbow 64. In elbow 64, light traveling through barrel 64 is deflected to eyepiece 66.

In FIGS. 4C and 4D two support-handles 68 are apparent. Support handles 68 are attached to elbow 64 by handle hinges 70. Just as other hinges of periscope 31, handle hinges 70 are lockable in two positions: in place, as depicted in FIG. 4D, and folded, as depicted in FIG. 4C. Support handles 68 of periscope 31 in FIG. 4 are as described hereinabove and in FIG. 3 for portable periscope 30.

Although many embodiments of an articulated periscope of the present invention, such as 31, can be designed based upon the teachings hereinabove, the embodiment exemplified by FIG. 4 represents one of the more preferred embodiments. The width of segments 36, 38 and 40, the length of eyepiece 66 together with the coplanarity of the motion of hinges 46 and 52 allows periscope 31, when folded, to have a substantially rectangular shape (FIG. 4B) that is exceptionally convenient for carrying, increasing the portability of periscope 31. Further the process of assembling barrel 34 of an articulated periscope, such as 31, a simple unfolding and snapping into place of segments is simpler then the assembly of barrel 34 of a periscope, such as 30, where barrel 34 is disassembled into separate segments

The embodiment of the present invention depicted in FIG. 4 shows periscope 31 with a three-segment two-hinged articulated barrel. It is clear that an articulated periscope of the present invention where the barrel is divided to two, four or even more segments, is easily implementable. Further, although the embodiment of the present invention depicted in FIG. 4 shows articulated periscope 31, where the respective motions or the two hinges 52 and 46 are coplanar, it is possible to provide a periscope of the present invention where the hinges about which the periscope barrel folds are not coplanar.

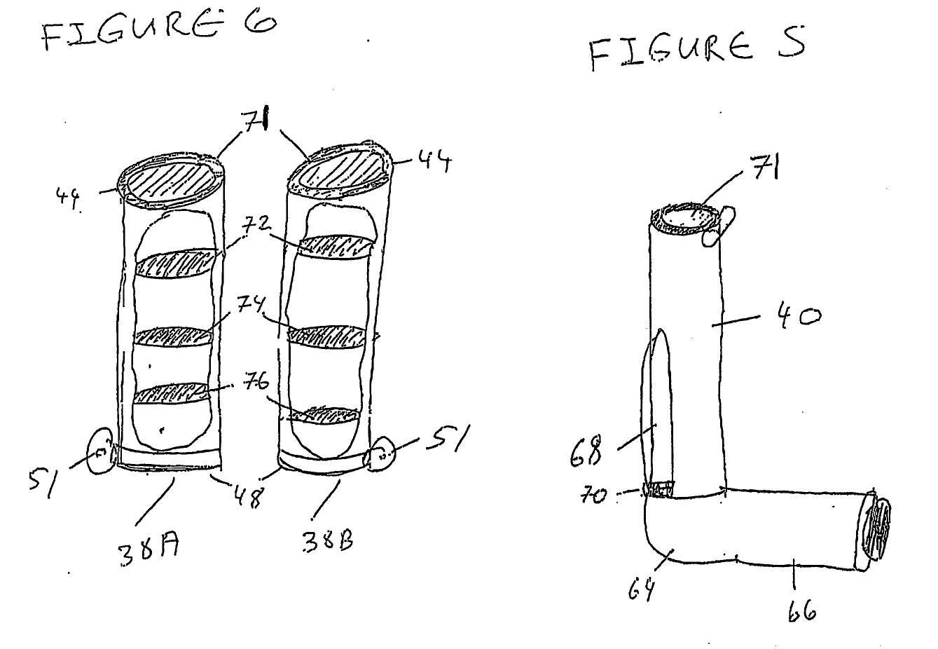

Segments 36, 38 and 40 of barrel 34 as depicted hereinabove for both periscopes 30 and 31 have been considered as substantially hollow tubes. It is clear to one skilled in the art that in some embodiments of the present invention it is preferable to attach optical elements that are substantially transparent to some or all frequencies of light to segments 36, 38 and 40. Such transparent elements can prevent the entry of contamination to barrel 34. For example, depicted in FIG. 5 is polarization filter 71 attached to rim 50 of bottom segment 40. Polarization filter 71 physically protects optical elements in elbow 64 and eyepiece 66 from contamination and at the some time polarizes light traveling through barrel 34 before it is deflected by elbow 64 to eyepiece 66.

As stated hereinabove, a periscope of the present invention is preferably equipped with optics having a Newtonian configuration. As known to one skilled in the arts, the use of optics having a Newtonian configuration gives a real image with a real pupil, and magnification and field-of-view that are not limited.

The use of optics having a Newtonian configuration in a periscope of the present invention allows the use of a zoom lens in place of an objective lens. Further, optics having a Newtonian configuration allow that eyepiece 66 be configured for attachment of various optical devices such as cameras, electronic video cameras, FLIR (far-looking infrared) detectors and light amplifiers such as “starlight scopes”. Also, it is possible to configure eyepiece 66 so as to be easily attachable and detachable from elbow 64. This allows various configurations or eyepiece 66 with many and varied lenses and filters to be used for various purposes.

Most importantly, when a periscope of the present invention is supplied with optics having a Newtonian configuration, one, some or all of barrel segments, such as 36, 38 and 40 can include an afocal set of optical lenses. Each segment having lenses includes an objective lens, a field lens and an eye lens. Each such segment can be configured with a set of optical lenses to have a desired degree of magnification.

In FIG. 6 are depicted two middle segments 38A and 38B, useable with a portable periscope 30 as depicted in FIG. 3. Both 38A and 38B have a polarizing filter 71 to prevent contamination from entering the segment itself, as well as an objective lens 72, a field lens 74 and an eye lens 76. The lenses of middle segment 38A are chosen so that middle segment 38A has a 2×-magnification. The lenses of middle segment 38B are chosen so that middle segment 38B has a 4×-magnification.

Depending on the magnification desired, the user of a periscope 30 chooses to use either middle segment 38A or 38B. As a result of the Newtonian optics and the a focal nature of the lenses in middle segments 38A and 38B, the image observed is clear and sharp. In addition, the user can choose to stack middle segments 38A and 38B one on top of the other, simultaneously using both 38A and 38B to achieve an 8× magnification.

In a second non-depicted example, a user making use of a periscope 30 as depicted in FIG. 3 can have two or more stackable middle segments with no magnification. To increase the length of barrel 34 the user stacks as many middle segments to make a barrel 34 as long as desired. As a result of the Newtonian optics and the afocal nature of the lenses in the middle segments, the image observed is clear and sharp.

When a periscope of the present invention has optics with a Newtonian configuration, virtually any number of afocal segments can be added if a user so desires.

It is clear to one skilled in the art, that stacking additional bawl segments as depicted in FIG. 6 for a portable periscope, such as 30, can also be implemented with the necessary modifications, to an articulated folding periscope, such as 31.

It is also important to note that it is a simple matter to add to a periscope of the present invention adapters and features that allow the reversible and temporary attachment of a periscope of the present invention to objects such as vehicles or tripods. Further, one skilled in the art is able to produce a rotating head, that is to say a periscope head, analogous to folding head 58, that can be rotated allowing a static observer to perform 360° observation.

While the invention has been described with respect to a limited number of embodiments, it will be appreciated that many variations, modifications and other applications of the invention may be made.

What is claimed is:

1. A portable periscope for the observation of an object by an observer comprising:
a) a periscope barrel;
b) a periscope head functionally associated with said periscope barrel configured to deflect light from the object into said periscope barrel; and
c) a periscope elbow functionally associated with said periscope barrel configured to deflect light traveling through said barrel to said observer;
wherein said periscope barrel is configured to be reversibly collapsible into at least two segmenting and wherein:
when not collapsed, said periscope buffer is substantially straight and defines a path for said deflected light and when collapsed, said periscope barrel does not define a path for said deflected light.

2. The periscope of claim 1 wherein said periscope barrel is articulated and said at least two segments se mutually attached with hinges.

3. The periscope of claim 2 wherein a motion or said hinges is coplanar.

4. The periscope of claim 2 wherein said articulated periscope barrel is collapsible to at least three segments and wherein the motion of all said hinges is coplanar.

5. The periscope of claim 1 further comprising a plurality of lenses.

6. The periscope of claim 5 wherein at least one of said plurality of lenses is attached to a segment of said barrel.

7. The periscope of claim 5 wherein said plurality or lenses have a Newtonian configuration.

8. The periscope of claim 1 where in at least one of said segments there is a field lens.
